(19) United States
(12) Patent Application Publication
(10) Pub. No.: US 2018/0034947 A1
(43) Pub. Date: Feb. 1, 2018

(54) STAND-ALONE TYPE MOBILE PHONE SANDWICH SHEET FOR SECURING ACCESSORIES

(71) Applicant: Shenzhen Tomtoc Technology Co., Ltd., Shenzhen (CN)

(72) Inventor: Ning MENG, Shenzhen (CN)

(21) Appl. No.: 15/249,846

(22) Filed: Aug. 29, 2016

(30) Foreign Application Priority Data
Jul. 26, 2016 (CN) 201620792075.2

(51) Int. Cl. H04M 1/02; H04B 1/3827

(52) U.S. Cl. CPC H04M 1/026; H04B 1/3833

(57) ABSTRACT

The present invention discloses a stand-alone type mobile phone sandwich sheet for securing accessories, including at least one sandwich piece, wherein the sandwich piece includes a sandwich piece body and an extension portion; the extension portion is formed by extending one end of the sandwich piece body and includes an accessory fixing mechanism capable of being provided with an external-source accessory; the sandwich piece body is accommodated in a gap formed between a mobile phone and a mobile phone cover; and the extension portion is located outside the gap formed between the mobile phone and the mobile phone cover. The present invention makes full use of the gap formed between the mobile phone and the mobile phone cover without destroying the overall style of the existing mobile phone/mobile phone cover of a user, is broad in applicability and can undergo cross use among multiple types of products.

### BACKGROUND OF THE INVENTION

### Technical Field

The present invention belongs to the technical field of accessory products for mobile phones, and in particular to a stand-alone type mobile phone sandwich sheet for securing accessories.

### 2. Description of Related Art

A mobile phone is not only a tool capable of answering a call, but also a tool integrating the functions of office work, entertainment, games and the like. When in various environments while traveling, at home, in bed and the like, people tend to kill longer and longer amounts of time with their mobile phone. A mobile phone pendant, or in other words, an accessory, is diverse in type and mainly plays the role of decorating the mobile phone, while some pendants have other auxiliary functions.

However, in consideration of cost, stability, applicable range, compatibility and other factors, the design for hanging the accessory (for example, a hole, a hook, a perforation and other designs for hanging the accessory) has been canceled in most of the mobile phones in the market at present. A user may not directly bind other accessories or fixing devices with the mobile phone, and thus, a certain inconvenience is brought to the life and work of the user.

A mobile phone shell or mobile cover also belongs to accessory products of mobile phones (in the present patent, the mobile phone shell and the mobile cover have the same meaning) and mainly plays a role of protecting the mobile phone. Some of the mobile phone covers have a design for hanging an accessory, such as a hook, a perforation and others for the accessory. For a mobile phone cover already having a hanging accessory in design, the relatively complex firmware added for enhancing the reliability destroys the overall simplicity.

For users who have bought products such as a mobile phone cover having no hook, perforation and other designs, it is difficult to bind other accessories or fixing devices with the mobile phone in the event of not separately purchasing a new product.

### BRIEF SUMMARY OF THE INVENTION

The technical problem to be solved by the present invention is as follows: a hook or a hole for securing accessories must be bound with a mobile phone shell or a mobile phone cover. If an existing mobile phone shell or a mobile phone cover of a user has no such design, he/she has to repeat the purchase, thereby increasing the cost for the user, what's worse, the user must abandon the mobile phone shell or mobile phone cover used currently, and meanwhile, the range for the user to select the mobile phone shell or cover products is greatly reduced; moreover, the design of the hook or hole as being wholly integrated with the mobile phone shell or cover cannot be split; and furthermore, the existing product design of the mobile phone shell or cover having the accessory hook or hole is complicate and is inconsistent with the trend of simple style of electronic products.

To solve the problem as described above, the present invention employs a technical solution as follows:

a stand-alone type mobile phone sandwich sheet for securing accessories includes at least one sandwich piece, wherein the sandwich piece includes a sandwich piece body and an extension portion; the extension portion is formed by extending one end of the sandwich piece body and includes an accessory fixing mechanism capable of being provided with an external-source accessory; the sandwich piece body is accommodated in a gap formed between a mobile phone and a mobile phone cover; and the extension portion is located outside the gap formed between the mobile phone and the mobile phone cover.

Further, the shape of the sandwich piece body fits the gap formed between the mobile phone and the mobile phone cover.

As a preferred implement, the stand-alone type mobile phone sandwich sheet for securing accessories includes two sandwich pieces, wherein the sandwich piece body of one sandwich piece is overlapped with the sandwich piece body of the other sandwich piece; the extension portion of one sandwich piece is overlapped with the extension portion of the other sandwich piece; and a sandwich layer is formed between the two sandwich pieces.

As a preferred implement, the sandwich layer is internally provided with an enhancing member.

As a preferred implement, the sandwich piece is made from a textile cloth, plastic, paper or metal material.

As a preferred implement, the accessory fixing mechanism is a hole formed in the extension portion, or a hook or binding tie configured on the extension portion.

As a preferred implement, the enhancing member is made from a metal, wood or plastic material.

As a preferred implement, the enhancing member is a sticker or an adhesive tape.

As a preferred implement, the sandwich piece is fixed at a side where the mobile cover and the mobile phone are laminated.

As a preferred implement, the sandwich piece is stuck to the mobile phone cover.

The stand-alone type mobile phone sandwich sheet of the present invention at least has the following advantageous effects or advantages:

the stand-alone type mobile phone sandwich sheet creatively makes full use of a large-area interspace space between the mobile phone cover and the mobile phone by disposing at least one sandwich piece in the interspace; the sandwich piece includes the sandwich piece body and the extension portion; the sandwich piece body is accommodated in the gap formed between the mobile phone and the mobile phone cover; and the extension portion is located outside the gap formed between the mobile phone and the mobile phone cover and used for hanging and binding the external-source (third-party) accessory. The thickness of the stand-alone type mobile phone sandwich sheet is controlled reasonably, and particularly, at least two sandwich pieces are disposed in the interspace and form one sandwich layer, in which the enhancing member is disposed to enhance the overall strength of the sandwich layer.

When a user needs to hang or bind a third-party accessory on the mobile phone, or when the user needs to fix the mobile phone, if the mobile phone per se has a mobile phone shell/cover already, the present product of the stand-alone type mobile phone sandwich sheet can be added very simply and conveniently for hanging, binding or fixing the third-party accessory or fixing the mobile phone per se, without changing the existing configuration of the user.

The stand-alone type mobile phone sandwich sheet can be independent of the mobile phone and the mobile phone cover, or can be fixed at an inner side (i.e. a side laminated with the mobile phone) of the mobile phone cover, thereby facilitating installation and removal. Although being a sheet-like structure member smaller in thickness, the stand-alone type mobile phone sandwich sheet is very firm by being disposed in the gap formed between the mobile phone and the mobile phone cover and by depending on a friction force between the sandwich sheet and the mobile phone and/or mobile phone cover, and can completely bear the self weight of the accessory after hanging or binding the third-party accessory.

In view of the stand-alone type mobile phone sandwich sheet being disposed in the gap formed between the mobile phone and the mobile phone cover, the present product will not destroy the overall style of the existing mobile phone/mobile phone cover of the user.

The stand-alone type mobile phone sandwich sheet is broad in applicability and can undergo cross use among multiple types of products. In the meantime, the stand-alone type mobile phone sandwich sheet is low in cost and easy to popularize and promote among mobile phone users.

### BRIEF DESCRIPTION OF THE SEVERAL VIEWS OF THE DRAWINGS

FIG. 1 is a schematic diagram of a stand-alone type mobile phone sandwich sheet having a single layer of sandwich piece as described in an embodiment.

FIG. 2 is a schematic diagram of a stand-alone type mobile phone sandwich sheet having two layers of sandwich pieces as described in an embodiment.

FIG. 3 is a schematic diagram of a stand-alone type mobile phone sandwich sheet having two layers of sandwich pieces between which an enhancing member is disposed as described in an embodiment.

Reference signs are illustrated as follows: 1. mobile phone cover; 2. mobile phone; 3. sandwich piece; 31. sandwich piece body; 32. extension portion; 4. enhancing member.

### DETAILED DESCRIPTION OF THE INVENTION

The present invention will be further illustrated below in combination with the accompanying drawings and the embodiments.

For the sake of description, “left”, “right”, “up” and “down” as mentioned in the context are consist with the directions of “left”, “right”, “up” and “down” in the drawings per se. It should be noted that the embodiments and the features therein in the present invention can be mutually combined in the absence of conflicts.

### Embodiment 1

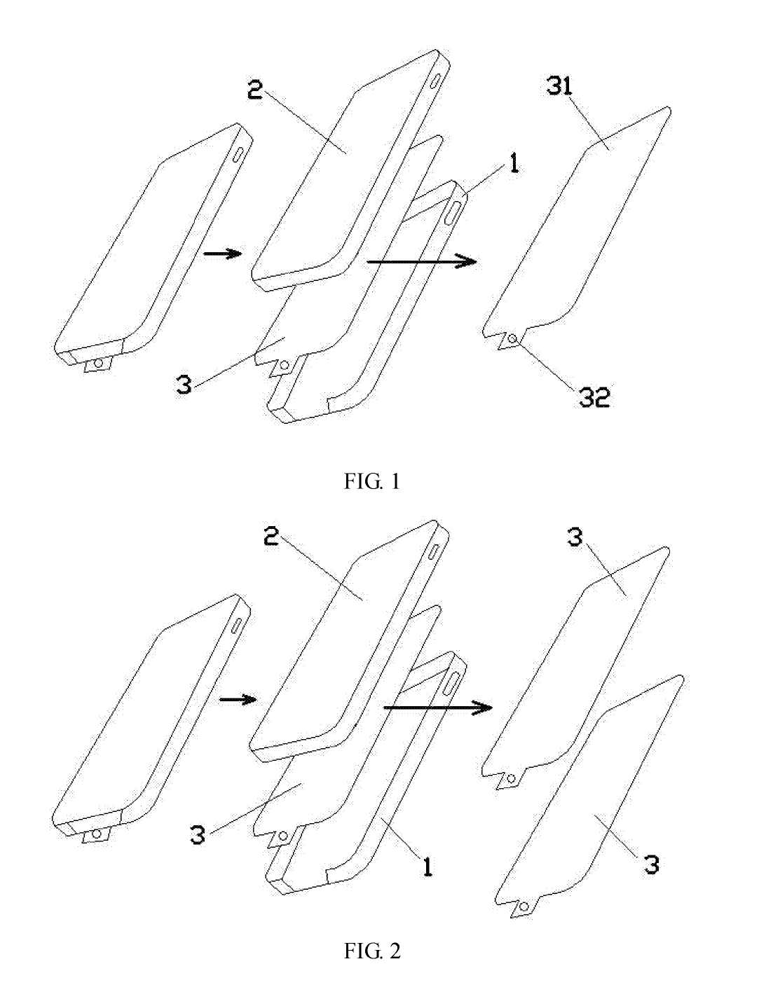

As shown in FIG. 1, the stand-alone type mobile phone sandwich sheet for securing accessories as described in the present embodiment makes use of a large-area interspace space between the mobile phone shell and the mobile phone. A sandwich piece 3 is disposed between the mobile phone cover 1 and the mobile phone 2. Structurally speaking, the sandwich piece 3 includes a sandwich piece body 31 and an extension portion 32; and the sandwich piece body 31 and the extension portion 32 are preferably of an integral structure, or the sandwich piece body 31 and the extension portion 32 are spliced into a whole. The sandwich piece 3 is of a sheet-like structure member and fits an inner side of the mobile phone cover 1 in terms of external shape and size. The sandwich piece 3 is made from such material as a textile cloth, a PVC material, and a paper material, or can be made from a metal material, such as metal aluminum and an alloy. There is no strict limitation on the material for manufacturing the sandwich piece 3 in the present embodiment, and any slim sheet-like member meets the requirement of the present invention.

Preferably, the sandwich piece body 31 and the extension portion 32 are of an integral structure; and the extension portion 32 is formed by extending one end of the sandwich piece body 31 and is located outside the gap formed between the mobile phone 2 and the mobile phone cover 1.

In addition to possibly being disposed in the gap between the mobile phone cover 1 and the mobile phone 2 independently, the sandwich piece 3 can be directly fixed at the inner side of the mobile phone shell/cover to be combined with the mobile phone shell/mobile phone cover as a whole. In such a way, the material selection of the sandwich piece 3 and the design of the sandwich layer 3 can be unnecessary. Preferably, one face of the sandwich piece 3 is directly stuck to a back face of the mobile phone, or an inner side of the mobile phone cover 1, with a backing adhesive.

The extension portion 32 is used for hanging and binding a third-party (external-source) accessory. The extension portion 32 is provided with an accessory fixing mechanism (not marked in the drawings); and the accessory fixing mechanism is preferably a hole formed in the extension portion 32, or a hook or a binding tie configured on the extension portion 32.

The principle of the stand-alone type mobile phone sandwich sheet for securing accessories as described in the present embodiment is illustrated as follows: the contact between most of the existing mobile phones and the mobile phone shells/covers is extremely tight, the mobile phones are wrapped extremely firmly, and thus, the interspaces therebetween are very small. If a third-party slim object (the sandwich piece 3) having an external surface higher in friction coefficient is disposed between the two, the external force required for pulling out the third-party object (the sandwich piece 3) from the gap is far more than the gravity force of the mobile phone plus the mobile phone shell/cover, without detaching the mobile phone shell/cover. Further, a conclusion is obtained as follows: the third-party object (the sandwich piece 3) in a form as described above can be used for fixing other accessories or fixing the mobile phone per se.

### Embodiment 2

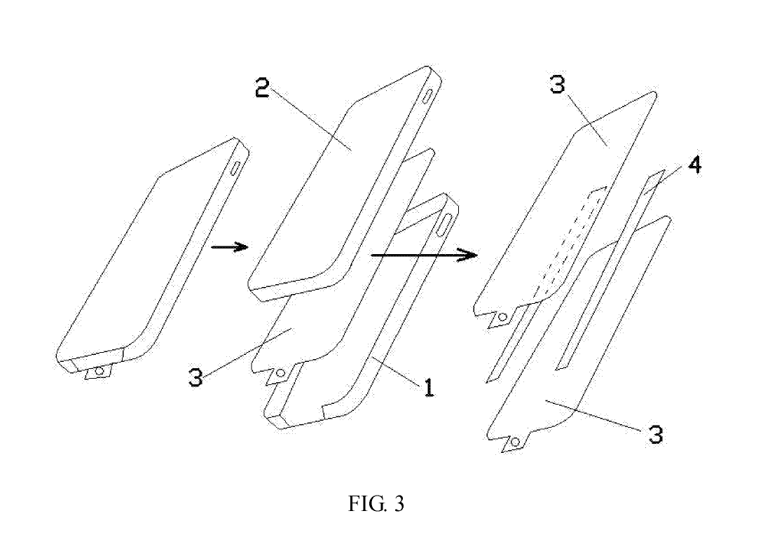

As shown in FIG. 2, the stand-alone type mobile phone sandwich sheet for securing accessories as described in the present embodiment includes two sandwich pieces 3, wherein the sandwich piece body 31 of one sandwich piece 3 is overlapped with the sandwich piece body 31 of the other sandwich piece 3; the extension portion 32 of one sandwich piece 3 is overlapped with the extension portion 32 of the other sandwich piece 3; and a sandwich layer is formed between the two sandwich pieces 3.

The two sandwich pieces 3 are disposed to possibly reduce the deformation degree of the sandwich pieces 3 when the extension portions 32 are pulled with an external force, thereby further enhancing the overall strength of the stand-alone type mobile phone sandwich sheet. The description remained is the same as that described in Embodiment 1, and Embodiment 1 can be referred to, and may be optimized and improved on this basis.

### Embodiment 3

As shown in FIG. 3, the stand-alone type mobile phone sandwich sheet for securing accessories as described in the present embodiment includes two sandwich pieces 3, wherein the two sandwich pieces 3 form a sandwich layer. The sandwich layer is internally provided with an enhancing member 4, which is made from a metal, wood or plastic material, and preferably, is made from an ultra-thin wood sheet material, a bamboo sheet material, a metal material, a plastic material and the like; the enhancing member 4 is fixed between the upper and lower two sandwich pieces 3 for preventing the present product from being reduced in deformation degree when pulled with an external force in a use process, thereby further reducing the detachment risk of the present product. For the convenience of implementation, the enhancing member 4 is preferably a sticker or an adhesive tape stuck between the two sandwich pieces 3. The description remained is the same as that described in Embodiments 1 and 2, and Embodiments 1 and 2 can be referred to, and may be optimized and improved on this basis.

In the description of the present specification, the description of reference terms such as “embodiment”, “example”, “specific example”, or “some examples” is intended to indicate the inclusion of a specific method, device or feature as described by said embodiment or example into at least one embodiment or example of the present embodiment. In the present specification, the schematic expressions of the terms above do not necessarily target at identical embodiments or examples, and the specific feature, method, device or feature as described can be incorporated in any one or more embodiments or examples in an appropriate way. In addition, those skilled in the art may incorporate and combine different embodiments or examples and the features of different embodiments or examples as described in the present specification.

The present invention is further illustrated above in combination with the embodiments, but is not limited to the implements above, and various variations can be made within the range of knowledge as possessed by those of ordinary skills in the art without departing from the spirit of the present invention.

1. A stand-alone type mobile phone sandwich sheet for securing accessories, comprising at least one sandwich piece, wherein the sandwich piece comprises a sandwich piece body not made from paper and an extension portions the extension portion being formed by integrally extending from one end of the sandwich piece body and comprising an accessory fixing mechanism capable of being provided with an external-source accessory the sandwich piece body being accommodated in a gap formed between a mobile phone and a mobile phone cover, the extension portion being located outside the gap formed between the mobile phone and the mobile phone cover.

2. The stand-alone type mobile phone sandwich sheet for securing accessories according to claim 1, wherein the shape of the sandwich piece body fits the gap formed between the mobile phone and the mobile phone cover.

3. The stand-alone type mobile phone sandwich sheet for securing accessories according to claim 2, further comprising one sandwich piece, wherein the sandwich piece body of one sandwich piece is overlapped with the sandwich piece body of the other sandwich piece, the extension portion of one sandwich piece being overlapped with the extension portion of the other sandwich piece, a sandwich layer being formed between the two sandwich pieces.

4. The stand-alone type mobile phone sandwich sheet for securing accessories according to claim 3, wherein the sandwich layer is internally provided with an enhancing member.

5. The stand-alone type mobile phone sandwich sheet for securing accessories according to claim 1, wherein the sandwich piece is made from a textile cloth, plastic, or metal material.

6. The stand-alone type mobile phone sandwich sheet for securing accessories according to claim 1, wherein the accessory fixing mechanism is a hole formed in the extension portion, or a hook or binding tie configured on the extension portion.

7. The stand-alone type mobile phone sandwich sheet for securing accessories according to claim 1, wherein the enhancing member is made from a metal, wood or plastic material.

8. The stand-alone type mobile phone sandwich sheet for securing accessories according to claim 1, wherein the enhancing member is a sticker or an adhesive tape.

9. The stand-alone type mobile phone sandwich sheet for securing accessories according to claim 1, wherein the sandwich piece is fixed at a side where the mobile phone cover and the mobile are laminated.

10. The stand-alone type mobile phone sandwich sheet for securing accessories according to claim 9, wherein the sandwich piece is stuck to the mobile phone cover.

11. The stand-alone type mobile phone sandwich sheet for securing accessories according to claim 2, wherein the sandwich piece is made from a textile cloth, plastic, paper or metal material.

12. The stand-alone type mobile phone sandwich sheet for securing accessories according to claim 3, wherein the sandwich piece is made from a textile cloth, plastic, paper or metal material.

13. A mobile phone accessory for accommodating a mobile phone, comprising:
a mobile phone cover for fittedly accommodating the mobile phone; and
a stand-alone type mobile phone sandwich sheet, which comprises:
at least one sandwich piece comprising a sandwich piece body not made from paper and an extension portion, the extension portion integrally extending from one end of the sandwich piece body and comprising an accessory fixing mechanism, the sandwich piece body being accommodated in a gap formed between the mobile phone and the mobile phone cover, the extension portion being located outside the gap formed between the mobile phone and the mobile phone cover, so that when the mobile phone is accommodated in the mobile phone cover, the extension portion is capable of being hung on the external-source accessory through the accessory fixing mechanism.

14. The mobile phone accessory according to claim 13, wherein the shape of the sandwich piece body fits the gap formed between the mobile phone and the mobile phone cover.

15. The mobile phone accessory according to claim 14, further comprising one sandwich piece, wherein the sandwich piece body of one sandwich piece is overlapped with the sandwich piece body of the other sandwich piece, the extension portion of one sandwich piece being overlapped with the extension portion of the other sandwich piece, a sandwich layer being formed between the two sandwich pieces.

16. The mobile phone accessory according to claim 14, wherein the sandwich layer is internally provided with an enhancing member, the enhancing member being made from a metal, wood or plastic material.

17. The mobile phone accessory according to claim 14, wherein the sandwich piece is made from a textile cloth, plastic, or metal material.

18. The mobile phone accessory according to claim 14, wherein the accessory fixing mechanism is a hole formed in the extension portion, or a hook or binding tie configured on the extension portion.

19. The mobile phone accessory according to claim 14, wherein the sandwich layer is internally provided with an enhancing member, the enhancing member being a sticker or an adhesive tape.

20. The mobile phone cover according to claim 14, wherein the sandwich piece is fixed on the mobile phone cover on a surface on which the mobile phone cover and the mobile phone are laminated.
